(19) United States
(12) Patent Application Publication
(10) Pub. No.: US 2015/0100435 A1
(43) Pub. Date: Apr. 9, 2015

(54) METHODS AND SYSTEMS FOR MANAGING BIDS FOR ONLINE CONTENT BASED ON MERCHANT INVENTORY LEVELS

(71) Applicant: GOOGLE INC., Mountain View, CA (US)

(72) Inventors: Jason Robert Richard Sanio, Mountain View, CA (US); Courtney Hampson, Mountain View, CA (US)

(73) Assignee: GOOGLE INC., Mountain View, CA (US)

(21) Appl. No.: 14/045,099

(22) Filed: Oct. 3, 2013

(51) Int. Cl. G06Q 30/02; G06Q 10/08

(52) U.S. Cl. CPC G06Q 30/0275; G06Q 10/087
USPC 705/14.71

(57) ABSTRACT

A method for managing bids for online content item for display to a consumer based on merchant inventory levels. The method includes receiving a plurality of bidding levels associated with a merchant's product. Each bidding level includes an inventory level and a bid price. The method also includes receiving, by the computing device, a first inventory value associated with the product. The first inventory value represents the quantity of the product that the merchant has in inventory. The method further includes identifying a current bidding level from the plurality of bidding levels based at least in part on comparing the first inventory value to the plurality of bidding levels, the current bidding level including a current bid price. The method also includes selling an online content space to the merchant at the identified current bid price. The online content space is for displaying the online content item to the consumer.

### BACKGROUND

This specification relates to serving online content to consumers of products or services associated with the online content and, more particularly, to methods and systems for adjusting merchant bidding for serving online content to a consumer based on a merchant's inventory levels for a particular product or service offered for sale by the merchant.

Internet publishers of publications, such as websites, may sell online content space (e.g., advertisement space on a web site) to merchants who wish to advertise online. Some publishers offer online content space at a fixed rate, while other publishers may offer online content space based on competitive bidding between multiple merchants. Some merchants purchase online content space for a particular product they offer for sale, and they may maintain an inventory of that product. Merchants must make decisions as to when they should advertise and/or how much they are willing to spend on advertising the sale of that product. The decision-making process may be performed without considering present inventory levels. Thus, the merchant may over-advertise or overspend on advertisements when their inventory levels for the product are restricted, or may under-advertise or underspend when their inventory levels for the product are high.

### BRIEF DESCRIPTION OF THE DISCLOSURE

In one aspect, a computer-implemented method for managing bids associated with serving an online content item for display to a consumer based on merchant inventory levels is provided. The method is implemented using a computing device in communication with a memory. The method includes receiving, in the memory, a plurality of bidding levels associated with a product of a merchant. Each bidding level includes an inventory level and a bid price. The method also includes receiving, by the computing device, a first inventory value associated with the product. The first inventory value represents the quantity of the product that the merchant has in inventory. The method further includes identifying a current bidding level from the plurality of bidding levels based at least in part on comparing the first inventory value to the plurality of bidding levels. The current bidding level includes a current bid price. The method also includes selling an online content space to the merchant at the identified current bid price. The online content space is for displaying the online content item to the consumer.

In another aspect, a computer system is provided. The computer system includes at least one processor and at least one memory comprising computer-executable instructions that, when executed by the at least one processor, cause the at least one processor to receive a plurality of bidding levels associated with a product of a merchant. Each bidding level includes an inventory level and a bid price. The computer-executable instructions also cause the processor to receive a first inventory value associated with the product. The first inventory value represents the quantity of the product that the merchant has in inventory. The computer-executable instructions further cause the processor to identify a current bidding level from the plurality of bidding levels based at least in part on comparing the first inventory value and the plurality of bidding levels. The current bidding level includes a current bid price. The computer-executable instructions also cause the processor to sell an online content space to the merchant at the identified current bid price. The online content space is for displaying an online content item to the consumer.

In yet another aspect, computer-readable storage media having computer-executable instructions embodied thereon are provided. When executed by at least one processor, the computer-executable instructions cause the processor to receive a plurality of bidding levels associated with a product of a merchant. Each bidding level includes an inventory level and a bid price. The computer-executable instructions also cause the processor to receive a first inventory value associated with the product. The first inventory value represents the quantity of the product that the merchant has in inventory. The computer-executable instructions further cause the processor to identify a current bidding level from the plurality of bidding levels based at least in part on comparing the first inventory value and the plurality of bidding levels. The current bidding level includes a current bid price. The computer-executable instructions also cause the processor to sell an online content space to the merchant at the identified current bid price. The online content space is for displaying the online content item to the consumer.

### BRIEF DESCRIPTION OF THE DRAWINGS

FIGS. 1-6 show example embodiments of the methods and systems described herein.

FIG. 1 is a diagram depicting an example networked environment for bidding on online content.

FIG. 2 is a block diagram of a computing device used for managing adjustable bids associated with serving online content items for display with publications to users based on merchant inventory levels, such as the various computing devices in the advertising environment shown in FIG. 1.

FIG. 3 is a diagram illustrating data flow between a content management system as shown in FIG. 1 and the computing device shown in FIG. 2.

FIG. 4 is another diagram illustrating data flow between a content management system as shown in FIG. 1 and the computing device shown in FIG. 2.

FIG. 5 is an example method for adjusting bids for an online content item using the computing device of FIG. 2 in the bidding environment shown in FIGS. 3 and 4.

FIG. 6 is a diagram of components of one or more example computing devices, for example computing device shown in FIG. 2, that may be used in the environments shown in FIGS. 1, 3, and 4.

Like reference numbers and designations in the various drawings indicate like elements.

### DETAILED DESCRIPTION OF THE DISCLOSURE

Embodiments of the methods and systems described herein enable a content management system (“CMS”) to adjust merchant bids for serving online content, such as advertisements, based on inventory levels received from a merchant. Merchants (i.e., content providers) purchase advertisement space (i.e., online content space) from publishers on the Internet, or other computer-based networked environments. These advertisement spaces are filled with online content items (i.e., advertisements) when online content items are served with publications. In the example embodiments described herein, the price that a particular merchant is willing to pay for advertisement space (i.e., the merchant's “bid price” for advertisements) may be changed based on the merchant's actual inventory level of a product.

In one embodiment, the merchant configures the CMS with a plurality of bidding levels for a given product. Each bidding level includes an inventory quantity range for the product, as well as an associated bid price that the merchant is willing to pay for serving the online content to a user whenever the merchant's current inventory levels fall within that range. For example, the merchant may wish to pay a first bid price when their inventory level exceeds 10 units, but is only willing to pay a lesser price when their inventory levels are between 1 and 9 units. Further, the merchant may not wish to advertise at all when they have no inventory in the product, and thus may configure a zero bid price when their inventory level is at zero.

During operation, the CMS provides or participates in auctions or other sales of online content space (i.e., the serving of advertisements by publishers). Merchants bid to have their advertisements presented with the online publications (i.e., served to users). The CMS retrieves either a static inventory level (such as a single value, perhaps updated on a daily or weekly basis by the merchant) or a dynamic inventory level (such as an automated data feed from a merchant's inventory system) from the merchant. The merchant's inventory level for the product is cross-referenced with the bidding levels to determine a bid price (i.e., the price that the merchant is currently willing to pay for serving content items for display to consumers based on their inventory levels). For example, a merchant may provide a first bid price to the CMS for use when its inventory levels are at a sufficiently high number (i.e., a first inventory level), and may provide a second bid price that is less than the first bid price when its inventory levels are at a lower level (i.e., a second inventory level lower than the first inventory level). Once the CMS determines the merchant's bid price (based on the inventory level), the CMS uses that bid price during auctioning and/or sales of online content space. Subsequently, the merchant may win a given auction/sale at the determined bid price (i.e., if the bid price is high enough to win the auction/sale), or the merchant may not win (i.e., if none of the auctions' prices are low enough to allow the merchant's bid price). As such, bidding levels for serving of online content are adjusted based on the merchant's current inventory levels.

The methods and systems described herein may be implemented using computer programming or engineering techniques including computer software, firmware, hardware, or any combination or subset thereof, wherein the technical effects may be achieved by performing at least one of the following steps: (a) receiving a plurality of bidding levels associated with a product of a merchant, each bidding level including an inventory level and a bid price; (b) receiving a first inventory value associated with the product, the first inventory value representing the quantity of the product that the merchant has in inventory; (c) identifying a current bidding level from the plurality of bidding levels based at least in part on comparing the first inventory value to the plurality of bidding levels, the current bidding level including a current bid price; (d) selling an online content space to the merchant at the identified current bid price, the online content space for displaying the online content item to the consumer; (e) submitting the current bid price during an auction for the online content space; (f) requesting an update to the first inventory value by the processor to the merchant; (g) receiving a plurality of bidding levels wherein each bidding level further includes a timeframe in which the bidding level is active; (h) receiving inventory values associated with the product from a merchant on a periodic basis; (i) comparing the current bid price to a plurality of bid prices associated with other merchants prior to selling the online content space to the merchant; (j) modifying the plurality of bidding levels based at least in part on a plurality of historical inventory levels associated with the product; (k) receiving, from the merchant, an advertising budget associated with the product; and (l) modifying the plurality of bidding levels based at least in part on the advertising budget.

The following detailed description illustrates embodiments of the disclosure by way of example and not by way of limitation. It is contemplated that the disclosure has general application to adjusting bids for online content items based on merchant inventory levels independently from, or in addition to, other factors that may influence bid levels.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

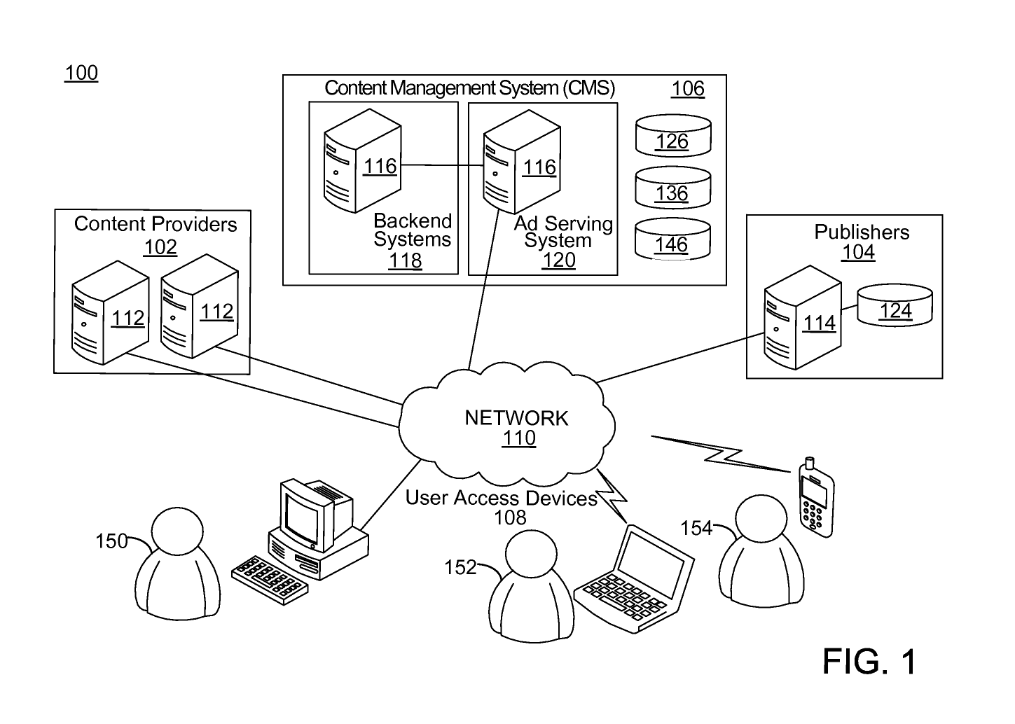

FIG. 1 is a diagram depicting an example networked environment for bidding on online content. With reference to FIG. 1, an example networked environment 100 may include one or more content providers 102 (alternatively referred to herein as merchants), one or more publishers 104, a content management system (CMS) 106, and one or more user access devices 108 (“client computing devices”), which may be coupled to a network 110. User access devices are used by users 150, 152, and 154. Each of the elements 102, 104, 106, 108 and 110 in FIG. 1 may be implemented or associated with hardware components, software components, or firmware components or any combination of such components. The elements 102, 104, 106, 108 and 110 can, for example, be implemented or associated with general purpose servers, software processes and engines, and/or various embedded systems. The elements 102, 104, 106 and 110 may serve, for example, as a content bidding and distribution network. In the example embodiment, content providers 102 include online advertisers, and CMS 106 is an advertising management system that enables one or more content providers 102 to bid on online content items.

The content providers 102 may include any entities that are associated with content (i.e., a content item or multiple content items). In some embodiments, the content includes any form of communication in which one or more products, services, ideas, messages, people, organizations or other items are identified and promoted (or otherwise communicated). Content is not limited to advertisements and commercial promotions. Rather, content may include public service announcements or any other types of notices, such as public notices published in printed or electronic press or broadcasts.

Content may be communicated via various mediums and in various forms. In some examples, content may be communicated through an interactive medium, such as the Internet, and may include graphical content (e.g., banner content), textual content, image content, audio content, video content, content combining one of more of any of such components, or any form of electronically delivered content. Content may include embedded information, such as embedded media, links, meta-information, and/or machine executable instructions. Content could also be communicated through RSS (Really Simple Syndication) feeds, radio channels, television channels, print media, and other media.

Content can refer to both a single “creative” and a “content group.” A creative refers to any entity that represents one content impression, also referred to herein as an advertisement, or “ad.” A content impression refers to any form of presentation of content such that it is viewable/receivable by a user. In some examples, a content impression may occur when content is displayed on a display device of a user access device (i.e., a “client computing device”). A content group refers, for example, to an entity that represents a group of creatives that share a common characteristic, such as having the same content selection and recommendation criteria. Content groups can be used to create a content campaign.

In some embodiments, one or more ads are affiliated with an “ad group.” An ad group includes one or more ads along with other associated information related to those ads, such as, for example and without limitation, a title, a headline, a budget, targeting criteria, and keywords. In the example embodiment, an ad group includes one ad and associated information. As used herein, the term “ad” and “ad group” may be used interchangeably, as some operations that are performed relative to an ad may also be performed relative to an ad group, and vice versa.

The content providers 102 may provide (or be otherwise associated with) products and/or services related to content. The content providers 102 may include or be associated with, for example, retailers, wholesalers, warehouses, manufacturers, distributors, health care providers, educational establishments, financial establishments, technology providers, energy providers, utility providers, or any other product or service providers or distributors.

The content providers 102 may directly or indirectly generate, maintain, and/or analyze content, which may be related to products or services offered by or otherwise associated with the content providers 102. The content providers 102 may include or maintain one or more data processing systems 112, such as servers or embedded systems, coupled to the network 110. The content providers 102 may include or maintain one or more processes that run on one or more data processing systems. In some embodiment, some content providers 102 maintain an inventory system related to products and/or services that they offer for sale. Further, content providers 102 may make static or dynamic inventory levels of the same products and/or services available to other computing devices within environment 100 such as, for example, to CMS 106.

The publishers 104 may include any entities that generate, maintain, provide, present and/or otherwise process publications in the environment 100. “Publishers,” in particular, include authors of publications, wherein authors may be individual persons, or, in the case of works made for hire, the proprietor(s) who hired the individual(s) responsible for creating the online publications. The term “publication” refers to various types of web-based, software application-based and/or otherwise presented information, including articles, discussion threads, reports, analyses, financial statements, music, video, graphics, search results, web page listings, information feeds (e.g., RSS feeds), television broadcasts, radio broadcasts, printed information, or any other form of information that may be presented to a user using a computing device such as one of user access devices 108.

In some implementations, the publishers 104 may include publishers with an Internet presence, such as online publication and news providers (e.g., online newspapers, online magazines, television websites, etc.), online service providers (e.g., financial service providers, health service providers, etc.), and the like. The publishers 104 can include software application providers, television broadcasters, radio broadcasters, satellite broadcasters, and other providers of publications. One or more of the publishers 104 may represent a publication network that is associated with the CMS 106.

The publishers 104 may receive requests from the user access devices 108 (or other elements in the environment 100) and provide or present publications to the requesting devices. The publishers may provide or present publications via various mediums and in various forms, including web based and non-web based mediums and forms. The publishers 104 may generate and/or maintain such publications and/or retrieve the publications from other network resources.

In addition to publications, the publishers 104 may be configured to integrate or combine retrieved publications with content that is related or relevant to the retrieved publication for display to users 150, 152, and 154. The relevant content may be provided from the CMS 106 and may be combined with a publication for display to users 150, 152, and 154. In some examples, the publishers 104 may retrieve a publication for display on a particular user access device 108 and then forward the publication to the user access device 108 along with code that causes content from the CMS 106 to be displayed to the user 150, 152, or 154. In other examples, the publishers 104 may retrieve a publication, retrieve relevant content (e.g., from the CMS 106 or the content providers 102), and then integrate the content and the publication to form a page for display to the user 150, 152, or 154. In still other examples, the publishers 104 may provide online content space for sale to advertisers, such as content providers 102. Such content space may be populated with content items from the content providers 102, and may be presented to the user 150, 152, or 154 along with the publications.

As noted above, one or more of the publishers 104 may represent a publication network. In such an implementation, the content providers 102 may be able to present content to users through this publication network. Further, in some embodiments, content providers 102 bid on online content items, for example, through CMS 106.

The publishers 104 may include or maintain one or more data processing systems 114, such as servers or embedded systems, coupled to the network 110. They may include or maintain one or more processes that run on data processing systems. In some examples, the publishers 104 may include one or more publication repositories 124 for storing publications and other information.

The CMS 106 manages content and provides various services to the content providers 102, the publishers 104, and the user access devices 108. The CMS 106 may store content in a content repository 126 and facilitate the distribution or selective provision and recommendation of content through the environment 100 to the user access devices 108. In the example embodiment, the CMS 106 enables the auctioning (i.e., a competitive bidding process between one or more merchants) or other sales of online content space.

The CMS 106 may include one or more data processing systems 116, such as servers or embedded systems, coupled to the network 110. It can also include one or more processes, such as server processes. In some examples, the CMS 106 may include a content serving system 120 and one or more backend processing systems 118. The content serving system 120 may include one or more data processing systems 116 and may perform functionality associated with delivering content to publishers or user access devices 108. The backend processing systems 118 may include one or more data processing systems 116 and may perform functionality associated with identifying relevant content to deliver, processing various rules, performing filtering processes, generating reports, maintaining accounts and usage information, auctioning online content items, and other backend system processing. The CMS 106 can use the backend processing systems 118 and the content serving system 120 to selectively recommend and provide relevant content from the content providers 102 through the publishers 104 to the user access devices 108.

The CMS 106 may include or access one or more crawling, indexing and searching modules (not shown). These modules may browse accessible resources (e.g., the World Wide Web, publisher content, data feeds, etc.) to identify, index and store information. The modules may browse information and create copies of the browsed information for subsequent processing. The modules may also check links, validate code, harvest information, and/or perform other maintenance or other tasks.

Searching modules may search information from various resources, such as the World Wide Web, publications, intranets, newsgroups, databases, and/or directories. The search modules may employ one or more known search or other processes to search data. In some implementations, the search modules may index crawled content and/or content received from data feeds to build one or more search indices. The search indices may be used to facilitate rapid retrieval of information relevant to a search query. Searching modules may also store search results including one or more of search query terms, search results elements, and ads impressions served.

The CMS 106 may include one or more interface or frontend modules for providing the various features to content providers, publishers, and user access devices. For example, the CMS 106 may provide one or more publisher front-end interfaces (PFEs) for allowing publishers to interact with the CMS 106. The CMS 106 may also provide one or more content provider front-end interfaces (CPFEs) for allowing content providers to interact with the CMS 106. In some examples, the front-end interfaces may be configured as web applications that provide users with network access to features available in the CMS 106.

The CMS 106 provides various content management features to the content providers 102. The CMS 106 features may allow users to set up user accounts, set account preferences, create content, select keywords for content, create campaigns or initiatives for multiple products or businesses, view reports associated with accounts, analyze costs and return on investment, selectively identify customers in different regions, selectively recommend and provide content to particular publishers, analyze financial information, analyze content performance, estimate content traffic, access keyword tools, add graphics and animations to content, and configure bidding levels and inventory retrieval as described herein.

The CMS 106 may allow the content providers 102 to create content and input keywords for which the content will appear. In some examples, the CMS 106 may provide content to user access devices or publishers when keywords associated with that content are included in a user request or a requested publication. The CMS 106 may also allow the content providers 102 to set bids for content. A bid may represent the maximum amount a content provider is willing to pay for each content impression, user click-through of content or other interaction with content. A click-through can include any action a user takes to select content. The content providers 102 may also choose a currency and monthly budget.

The CMS 106 may also allow the content providers 102 to view information about content impressions, which may be maintained by the CMS 106. The CMS 106 may be configured to determine and maintain the number of content impressions relative to a particular website or keyword. The CMS 106 may also determine and maintain the number of click-trough's for content as well as the ratio of click-trough's to impressions.

The CMS 106 may also allow the content providers 102 to select and/or create conversion types for content. A “conversion” may occur when a user consummates a transaction related to given content. A conversion could be defined to occur when a user clicks on content, for example a specific content item, is referred to the content provider's web page, and consummates a purchase there before leaving that web page. In another example, a conversion could be defined as the display of content to a user and a corresponding purchase on the content provider's web page within a predetermined time (e.g., seven days). The CMS 106 may store conversion data and other information in a conversion data repository 136.

The CMS 106 may allow the content providers 102 to input description information associated with content. This information could be used to assist the publishers 104 in determining content to publish. The content providers 102 may additionally input a cost/value associated with selected conversion types, such as a five dollar credit to the publishers 104 for each product or service purchased.

The CMS 106 may provide various features to the publishers 104. The CMS 106 may deliver content (associated with the content providers 102) to the user access devices 108 when users access publications from the publishers 104. The CMS 106 can be configured to deliver content that is relevant to publisher sites, publications, and publisher audiences.

In some examples, the CMS 106 may crawl publications provided by the publishers 104 and deliver content that is relevant to publisher sites, publications and publisher audiences based on the crawled publications. The CMS 106 may also selectively recommend and/or provide content based on user information and behavior, such as particular search queries performed on a search engine website. The CMS 106 may store such information in a general database 146. In some examples, the CMS 106 can add search to a publisher site and deliver content configured to provide appropriate and relevant content relative to search results generated by requests from visitors of the publisher site. A combination of these and other approaches can be used to deliver relevant content.

The CMS 106 may allow the publishers 104 to search and select specific products and services as well as associated content to be displayed with publications provided by the publishers 104. For example, the publishers 104 may search through content in the content repository 126 and select certain content for display with their publications.

The CMS 106 may be configured to selectively recommend and provide content created by the content providers 102 to the user access devices 108 directly or through the publishers 104. The CMS 106 may selectively recommend and provide content to a particular publisher 104 (as described in further detail herein) or a requesting user access device 108 when a user requests search results or loads a publication from the publisher 104.

In some implementations, the CMS 106 may manage and process financial transactions among and between elements in the environment 100. For example, the CMS 106 may credit accounts associated with the publishers 104 and debit accounts of the content providers 102. These and other transactions may be based on conversion data, impressions information and/or click-through rates received and maintained by the CMS 106.

“Computing devices”, for example user access devices 108, may include any devices capable of receiving information from the network 110. The user access devices 108 could include general computing components and/or embedded systems optimized with specific components for performing specific tasks. Examples of user access devices include personal computers (e.g., desktop computers), mobile computing devices, cell phones, smart phones, head-mounted computing devices, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed content providers 102, publishers 104 and/or user access devices 108, which may be discrete, integrated modules or distributed systems. Similarly, the environment 100 is not limited to a single CMS 106 and may include any number of integrated or distributed CMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes running on separate machines or a single process running on a single machine.

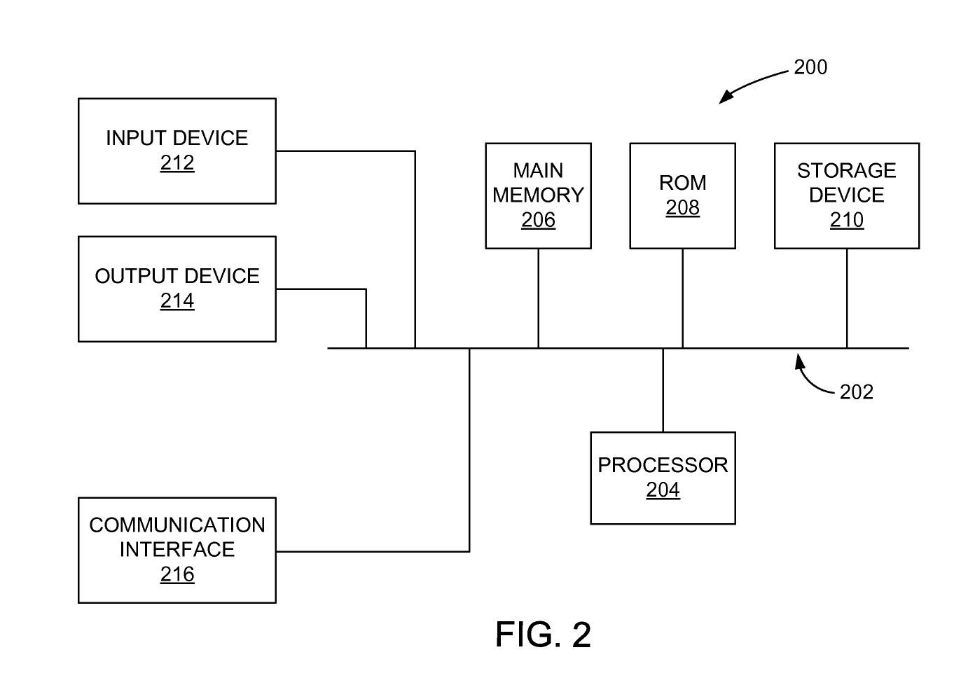

FIG. 2 is a block diagram of a computing device 200 used for managing adjustable bids associated with serving online content items for display with publications to users based on merchant inventory levels, such as the various computing devices in advertising environment 100 (shown in FIG. 1). FIG. 2 shows an example of a generic computing device 200 intended to represent various forms of digital computers, such as laptops, desktops, workstations, personal digital assistants, servers, blade servers, mainframes, and other appropriate computers. Computing device 200 is also intended to represent various forms of mobile devices, such as personal digital assistants, cellular telephones, smart phones, and other similar computing devices that could be used for communicating the bid prices and the inventory levels to the CMS 106. The components shown here, their connections and relationships, and their functions, are meant to be examples only, and are not meant to limit implementations of the subject matter described and/or claimed in this document.

In the example embodiment, computing device 200 could be user access device 108 or any of data processing devices 112, 114, or 116 (shown in FIG. 1). Computing device 200 may include a bus 202, a processor 204, a main memory 206, a read only memory (ROM) 208, a storage device 210, an input device 212, an output device 214, and a communication interface 216. Bus 202 may include a path that permits communication among the components of computing device 200.

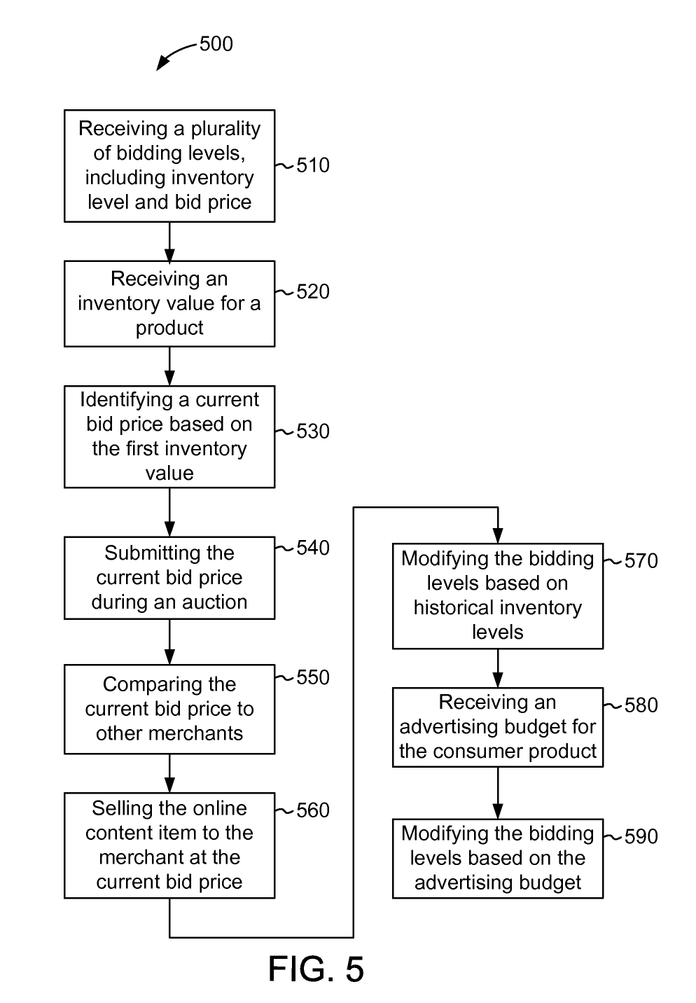

Processor 204 may include any type of conventional processor, microprocessor, or processing logic that interprets and executes instructions. Processor 204 can process instructions for execution within the computing device 200, including instructions stored in the memory 206 or on the storage device 210 to display graphical information for a GUI on an external input/output device, such as display 214 coupled to a high speed interface. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system). In some embodiments, processor 204 is transformed into a special purpose microprocessor by executing computer-executable instructions or by otherwise being programmed. For example, processor 204 may be programmed with instructions such as illustrated in FIG. 5.

Main memory 206 may include a random access memory (RAM) or another type of dynamic storage device that stores information and instructions for execution by processor 204. ROM 208 may include a conventional ROM device or another type of static storage device that stores static information and instructions for use by processor 204. Main memory 206 stores information within the computing device 200. In one implementation, main memory 206 is a volatile memory unit or units. In another implementation, main memory 206 is a non-volatile memory unit or units. Main memory 206 may also be another form of computer-readable medium, such as a magnetic or optical disk.

Storage device 210 may include a magnetic and/or optical recording medium and its corresponding drive. The storage device 210 is capable of providing mass storage for the computing device 200. In one implementation, the storage device 210 may be or contain a computer-readable medium, such as a floppy disk device, a hard disk device, an optical disk device, or a tape device, a flash memory or other similar solid state memory device, or an array of devices, including devices in a storage area network or cloud-based storage or other configurations. A computer program product can be tangibly embodied in an information carrier. The computer program product may also contain instructions that, when executed, perform one or more methods, such as those described above. The information carrier is a computer- or machine-readable medium, such as main memory 206, ROM 208, the storage device 210, or memory on processor 204.

The high speed controller manages bandwidth-intensive operations for the computing device 200, while the low speed controller manages lower bandwidth-intensive operations. Such allocation of functions is for purposes of example only. In one implementation, the high-speed controller is coupled to main memory 206, display 214 (e.g., through a graphics processor or accelerator), and to high-speed expansion ports, which may accept various expansion cards (not shown). In the implementation, low-speed controller is coupled to storage device 210 and low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Input device 212 may include a conventional mechanism that permits computing device 200 to receive commands, instructions, or other inputs from a user 150, 152, or 154, including visual, audio, touch, button presses, stylus taps, etc. Additionally, input device may receive location information. Accordingly, input device 212 may include, for example, a camera, a microphone, one or more buttons, a touch screen, and/or a GPS receiver. Output device 214 may include a conventional mechanism that outputs information to the user, including a display (including a touch screen) and/or a speaker. Communication interface 216 may include any transceiver-like mechanism that enables computing device 200 to communicate with other devices and/or systems. For example, communication interface 216 may include mechanisms for communicating with another device or system via a network, such as network 110 (shown in FIG. 1).

As described herein, computing device 200 facilitates the presentation of content from one or more publishers, along with one or more sets of sponsored content, for example ads, to a user. Computing device 200 may perform these and other operations in response to processor 204 executing software instructions contained in a computer-readable medium, such as memory 206. A computer-readable medium may be defined as a physical or logical memory device and/or carrier wave. The software instructions may be read into memory 206 from another computer-readable medium, such as data storage device 210, or from another device via communication interface 216. The software instructions contained in memory 206 may cause processor 204 to perform processes described herein. Alternatively, hardwired circuitry may be used in place of or in combination with software instructions to implement processes consistent with the subject matter herein. Thus, implementations consistent with the principles of the subject matter disclosed herein are not limited to any specific combination of hardware circuitry and software.

The computing device 200 may be implemented in a number of different forms, as shown in the figure. For example, it may be implemented as a standard server, or multiple times in a group of such servers. It may also be implemented as part of a rack server system. In addition, it may be implemented in a personal computer such as a laptop computer. Each of such devices may contain one or more of computing device 200, and an entire system may be made up of multiple computing devices 200 communicating with each other.

The processor 204 can execute instructions within the computing device 200, including instructions stored in the main memory 206. The processor may be implemented as chips that include separate and multiple analog and digital processors. The processor may provide, for example, for coordination of the other components of the device 200, such as control of user interfaces, applications run by device 200, and wireless communication by device 200.

Computing device 200 includes a processor 204, main memory 206, ROM 208, an input device 212, an output device such as a display 214, a communication interface 216, among other components including, for example, a receiver and a transceiver. The device 200 may also be provided with a storage device 210, such as a microdrive or other device, to provide additional storage. Each of the components are interconnected using various buses, and several of the components may be mounted on a common motherboard or in other manners as appropriate.

Computing device 200 may communicate wirelessly through communication interface 216, which may include digital signal processing circuitry where necessary. Communication interface 216 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver. In addition, short-range communication may occur, such as using a Bluetooth, WiFi, or other such transceiver (not shown). In addition, a GPS (Global Positioning system) receiver module may provide additional navigation- and location-related wireless data to device 200, which may be used as appropriate by applications running on device 200.

Computing device 200 may also communicate audibly using an audio codec, which may receive spoken information from a user and convert it to usable digital information. The audio codec may likewise generate audible sound for a user, such as through a speaker, e.g., in a handset of device. Such sound may include sound from voice telephone calls, may include recorded sound (e.g., voice messages, music files, etc.) and may also include sound generated by applications operating on computing device 200.

Computing device 200 may be implemented in a number of different forms. For example, it may be implemented as a cellular telephone, or as part of a smart phone, personal digital assistant, a computer tablet, or other similar mobile device.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 200) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing device 200 is configured to receive and/or retrieve electronic documents from various other computing devices connected to computing device 200 through a communication network, and store these electronic documents within at least one of memory 206, storage device 210, and ROM 208. Computing device 200 is further configured to manage and organize these electronic documents within at least one of memory 206, storage device 210, and ROM 208 using the techniques described herein.

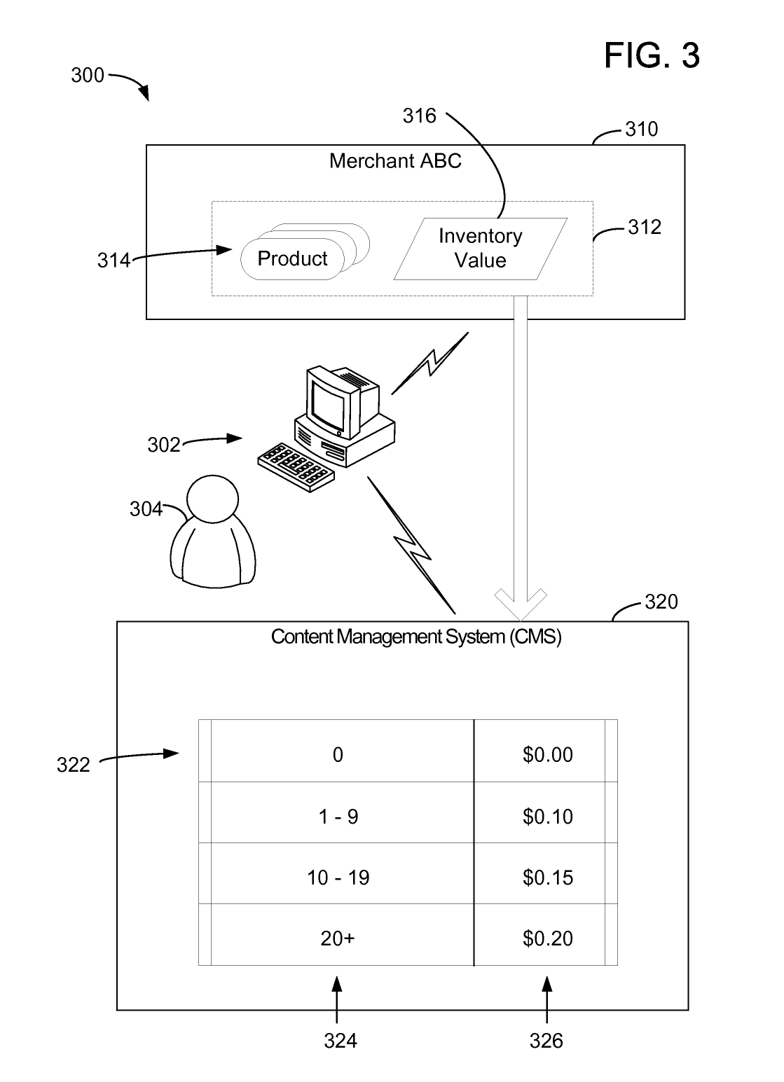

FIG. 3 is a diagram 300 illustrating data flow between a content management system (CMS) 320 and a merchant 310, and using one or more computing devices 200 (shown in FIG. 2). In some embodiments, CMS 320 may be similar to CMS 106 (shown in FIG. 1). In the example embodiment, the merchant 310, such as “Merchant ABC”, offers a product 314 for sale. The merchant 310 advertises the product 314 online through the CMS 320, which auctions advertisement space (i.e., online content space) to one or more merchants, and provides the advertisements (i.e., the online content items) to publishers 104 (shown in FIG. 1) for presentation to online users (i.e., potential consumers of product 314).

In the example embodiment, an administrator 304 communicates with CMS 320 and configures the CMS 320 with a plurality of bidding levels 322 associated with the product 314. In some embodiments, the administrator 304 is the merchant 310. In other embodiments, the administrator 304 is associated with the CMS 320. Each bidding level 322 includes an inventory level 324 and a bid price 326. The inventory level 324 represents a quantity of units of a product, such as product 314, and may be a single value (e.g., “0”), a range of values (e.g., “1-9” and “10-19”), or an open-ended range (e.g., “20+”). The bid price 326 represents an amount that the merchant 310 is willing to pay for an online content item (not shown in FIG. 3) if their inventory value 316 satisfies the associated inventory level 324. In the example embodiment, only one bid price 326 for a particular inventory level 324 is configured. Alternatively, additional bid prices 326 may be configured for each inventory level 324. For example, CMS 320 may allow merchants 310 to set different bidding levels for different types of online content items, such as “ad impressions”, or “conversions”, or other categorizations of online content items. In some embodiments, each bidding level further includes a timeframe in which the bidding level is active. As such, the CMS 320 may allow multiple bid prices 326 for each inventory level 324, or the CMS 320 may allow a merchant 310 to configure several pluralities of bidding levels 322, each for a different type of online content.

In the example embodiment, the merchant 310 maintains an inventory management system 312, which tracks an inventory value 316 of the product 314 automatically. The inventory value 316 represents how many units of the product 314 (i.e., a quantity of the product) that the merchant holds in inventory. In other embodiments, the merchant 310 provides an inventory value 316 for the product 314 manually, such as by an employee updating their inventory level for product 314 on a periodic basis. In the example embodiment, the CMS 320 is communicatively coupled to the inventory management system 312 such that the CMS 320 may request and/or receive updated values of inventory level 316 for product 314. In other embodiments, an administrator 304 may use a computing device 302 to manually update the inventory level 316 of the merchant 310 or manually transmit the inventory level 316 to the CMS 320.

During configuration, an administrator 304, such as the merchant 310, configures the plurality of bidding levels 322 within the CMS 320. More specifically, for a given product 314 that the merchant 310 is selling (and advertising), the administrator 304 configures a plurality of inventory levels 324 that define a value or range of values. For each inventory level 324, the administrator 304 also configures a bid price 326 that defines the amount that the merchant 310 is willing to bid for online content items. As such, the merchant 310 is able to configure and control the amount that the merchant 310 bids on auctions for online content items based at least in part on a fluctuating inventory level.

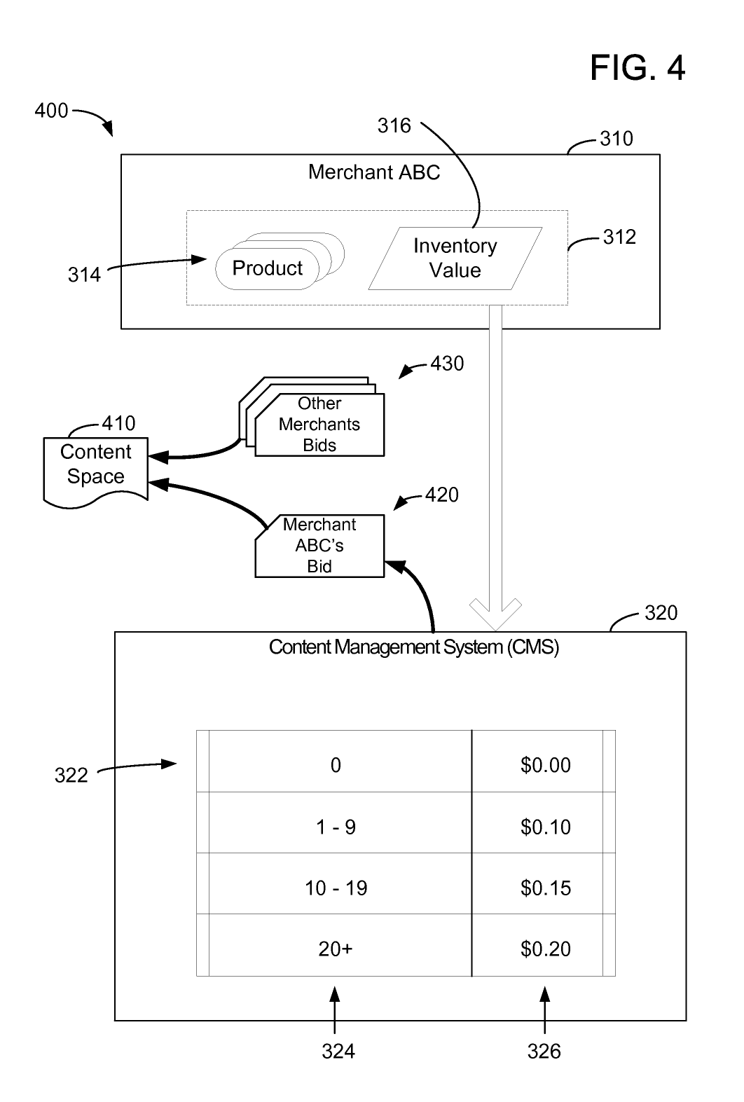

FIG. 4 is another diagram 400 illustrating data flow between CMS 320 and a merchant 310, and using one or more computing devices 200 (shown in FIG. 2). In some embodiments, CMS 320 may be similar to CMS 106 (shown in FIG. 1). In the example embodiment, merchant 310 participates in an online auction for an online content space 410, such as an advertisement space through a publisher such as publisher 104 (shown in FIG. 1). It should be understood, however, that while some of the embodiments described herein depict the context of auctioning online content spaces to a plurality of merchants, other types of sales transactions for online content spaces are within the context of this disclosure. For example, CMS 320 may provide an offer-and-acceptance style transaction between merchant 310 and publisher 104 (shown in FIG. 1), where the determined bid price (based on merchant's 310 inventory value 316) represents the price the merchant 310 is willing to pay, and either the publisher 104 is willing to accept, or is not.

During operation, in the example auctioning embodiment depicted in FIG. 4, an auction for the online content space 410 is conducted by CMS 320. Merchant 310 has an advertisement for the product 314, and desires participation in bidding for online advertisements. The merchant's 310 participation in the auction may be governed by several factors. In the example embodiment, the merchant's 310 inventory level 316 for the product 314 is one factor. CMS 320 identifies the inventory value 316 associated with the product 314. The CMS 320 may request an updated value from the merchant 310 (i.e., the CMS pulls the value from the merchant), or the merchant 310 may periodically update the CMS 320 with a current inventory value 316 (i.e., the merchant pushes the value to the CMS).

With the updated inventory value 316, the CMS 320 cross-references the inventory value 316 with the plurality of inventory levels 324 (i.e., from the plurality of bidding levels 322) to determine a corresponding bid price 326. During the auction for online content space, the merchant participates in the auction using this determined bid price 326. In other words, the determined bid price 326 is submitted as Merchant ABC's bid 420. Further, other merchants may also submit bids 430 for the same online content space 410, which may compete against merchant ABC's bid 420.

For example, consider a plurality of merchants participating in an auction for a single ad impression (i.e., an online content item that will be displayed to an online user in the online content space 410). Presume “Merchant ABC” 310 has a first product for sale, such as product 314, and that product's current inventory value is 12. Prior to or during the auction, the CMS 320 queries merchant's 310 inventory management system 312 and retrieves the inventory value 312 for the product 314 (e.g., “12”). The CMS 320 determines how much the merchant 310 is willing to bid during this auction by referencing the plurality of bidding levels 322 to determine what bid price 326 correlates to the current inventory level 324 of 12. The CMS 320 determines that merchant 310 is willing to bid “$0.15” for online content space in which they will advertise product 314. As such, during the auction with the other merchants, a bid price 326 of “$0.15” is submitted on behalf of merchant 310. If merchant 310 wins the auction, then the merchant 310 will pay the bid price 326 for the online content space.

During later auctions, merchant's 310 inventory level may have fluctuated. Presume that another auction occurs later, for another online content space similar to content space 410. The CMS 320 may re-query merchant's 310 inventory value 316 and find that the inventory quantity is now “8” (i.e., the merchant's quantity has changed since the above-described auction, such as through intervening sales of product 314). For this auction, the CMS 320 cross-references the merchant's 310 current inventory value 316 (i.e., “8”) against the plurality of bidding levels 322 to identify a bid price 326 of “$0.10”. Accordingly, CMS 320 submits merchant ABC's bid 420 as “$0.10” for this auction.

In some embodiments, the system may dynamically alter the bidding levels for a given merchant 310. Historical inventory levels may be examined over time for a merchant's product 314, and inventory levels 324 and/or bid prices 326 may be altered based on historical inventory quantities, conversion rates, or other data available to CMS 106. Further, the merchant 310 may provide an advertising budget associated with the product 314, and the inventory levels 324 and/or associated prices 326 may be altered by the CMS 320 based on the advertising budget. As such, merchant bids 420 may be dynamically altered by the CMS 106.

As such, the example embodiment facilitates a user-customizable, tiered set of bidding levels for online content space based primarily on an inventory level of a product. The integration between the CMS 320 and the merchant inventory system 312 facilitates a dynamic system that auto-adjusts bids based on current inventory levels. The merchant configures how much they are willing to pay based on how much inventory they happen to have at the time. In some situations, a merchant may desire to pay more when their inventory is higher, or may desire to pay less when their inventory is lower. It should be understood that, while the example system described herein discuss inventory level as the only factor for adjusting bidding amounts for online content items, other factors may also influence the bidding without departing from the subject matter of this disclosure.

FIG. 5 is an example method 500 for adjusting bids for an online content space 410 (shown in FIG. 4) using the computing device 200 of FIG. 2 in the sales environments shown in FIGS. 3 and 4. Method 500 uses a computing device including a processor and a memory, such as CMS 106 (shown in FIG. 1), CMS 320 (shown in FIGS. 3 and 4), and/or computing device 200 (shown in FIG. 2). In the example embodiment, method 500 includes receiving 510, in the memory, a plurality of bidding levels associated with a consumer product of a merchant, each bidding level including an inventory level and a bid price. In some embodiments, each bidding level also includes a timeframe in which the bidding level is active. Method 500 also includes receiving 520, by the processor from the merchant, a first inventory value associated with the consumer product representing the quantity of the consumer product that the merchant has in inventory. In some embodiments, method 500 includes requesting an update to the first inventory value by the processor to the merchant.

Further, in the example embodiment, method 500 includes identifying 530 a current bidding level from the plurality of bidding levels based at least in part on comparing the first inventory value and the plurality of bidding levels, the current bidding level including a current bid price. In some embodiments, method 500 includes submitting the current bid price during an auction for the online content item. In other embodiments, method 500 further includes comparing the current bid price to a plurality of bid prices associated with other merchants prior to selling the online content item to the merchant. Method 500 also includes selling 560 the online content item to the merchant at the identified current bid price.

In some embodiments, method 500 also includes modifying 570, by the processor, the plurality of bidding levels based at least in part on a plurality of historical inventory levels associated with the consumer product. In other embodiments, method 500 includes receiving, from the merchant, an advertising budget associated with the consumer product, and modifying, by the processor, the plurality of bidding levels based at least in part on the advertising budget.

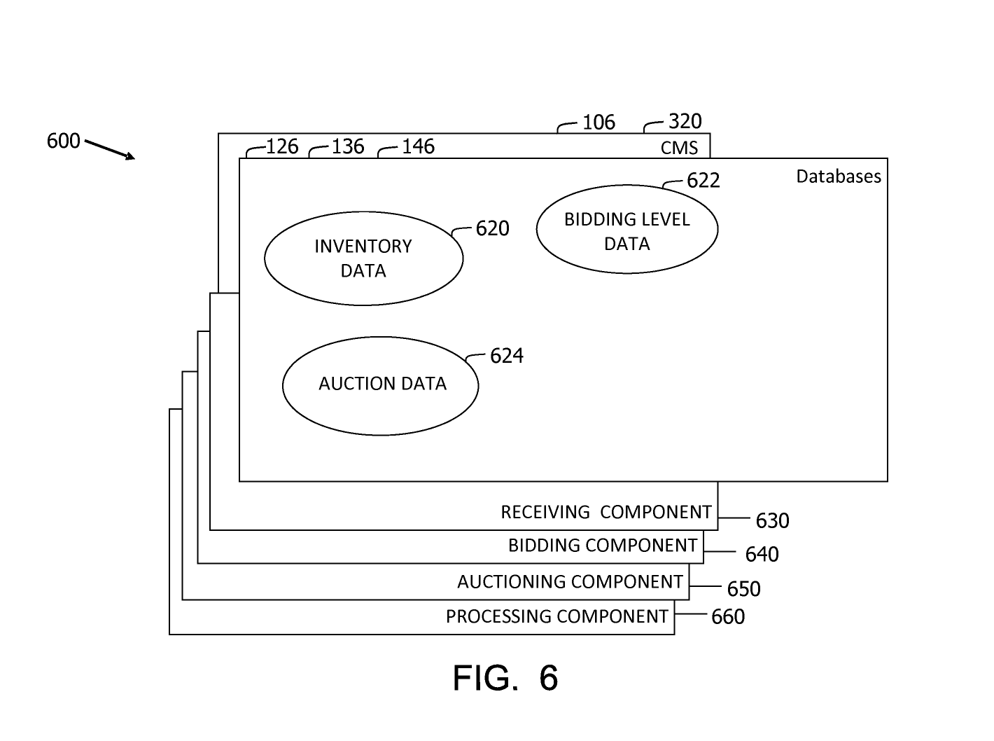

FIG. 6 is a diagram 600 of components of one or more example computing devices, for example computing device 200 (shown in FIG. 2), that may be used in the environments shown in FIGS. 1, 3, and 4. For example, one or more of computing devices 200 may form CMS 106, merchant system 102, and/or publisher system 104 (shown in FIG. 1), or CMS system 320 (shown in FIGS. 3 and 4). FIG. 6 further shows a configuration of databases 126, 136, and 146 (also shown in FIG. 1). Databases 126, 136, and 146 are coupled to several separate components within CMS 320, which perform specific tasks.

In the example embodiment, databases 126, 136, and 146 are divided into a plurality of sections, including but not limited to, an inventory data section 620, a bidding level data section 622, and an auction data section 624. These sections within databases 126, 136, and 146 are interconnected to retrieve information pertaining to the operations and components described below.

CMS 320 further includes a receiving component 630 for receiving and/or retrieving inventory data 620 and/or bidding level data 622 such as, for example, inventory value 316 and bidding levels 322 (shown in FIGS. 3 and 4). CMS 106 also includes a bidding component 640 for determining bid prices from bidding level data 622 using inventory data 620. CMS 106 additionally includes an auctioning component 650 for conducting and/or participating in auctions for online content items such as described in relation to FIG. 4. CMS 106 additionally includes a processing component 660 for performing other operations associated with adjusting bids for online content items based on merchant inventory levels.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the embodiments or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

While the disclosure has been described in terms of various specific embodiments, it will be recognized that the disclosure can be practiced with modification within the spirit and scope of the claims.

What is claimed is:

1. A computer-implemented method for managing bids associated with serving an online content item for display to a consumer based on merchant inventory levels, said method implemented using a computing device in communication with a memory, said method comprising:
receiving, in the memory, a plurality of bidding levels associated with a product of a merchant, each bidding level including an inventory level and a bid price;
receiving, by the computing device, a first inventory value associated with the product, the first inventory value representing the quantity of the product that the merchant has in inventory;
identifying a current bidding level from the plurality of bidding levels based at least in part on comparing the first inventory value to the plurality of bidding levels, the current bidding level including a current bid price; and
selling an online content space to the merchant at the identified current bid price, the online content space for displaying the online content item to the consumer.

2. The method of claim 1 further comprising submitting the current bid price during an auction for the online content space.

3. The method of claim 1, wherein receiving the first inventory value comprises requesting an update to the first inventory value by the processor to the merchant.

4. The method of claim 1, wherein receiving a plurality of bidding levels further comprises receiving a plurality of bidding levels wherein each bidding level further includes a timeframe in which the bidding level is active.

5. The method of claim 1, wherein receiving a first inventory value further comprises receiving inventory values associated with the product from a merchant on a periodic basis.

6. The method of claim 1 further comprising comparing the current bid price to a plurality of bid prices associated with other merchants prior to selling the online content space to the merchant.

7. The method of claim 1 further comprising modifying, by the processor, the plurality of bidding levels based at least in part on a plurality of historical inventory levels associated with the product.

8. The method of claim 1 further comprising:
receiving, from the merchant, an advertising budget associated with the product; and
modifying, by the processor, the plurality of bidding levels based at least in part on the advertising budget.

9. A computer system comprising:
at least one processor; and
at least one memory comprising computer-executable instructions that, when executed by said at least one processor, cause said at least one processor to:
receive a plurality of bidding levels associated with a product of a merchant, each bidding level including an inventory level and a bid price;
receive a first inventory value associated with the product, the first inventory value representing the quantity of the product that the merchant has in inventory;
identify a current bidding level from the plurality of bidding levels based at least in part on comparing the first inventory value and the plurality of bidding levels, the current bidding level including a current bid price; and
sell an online content space to the merchant at the identified current bid price, the online content space for displaying an online content item to the consumer.

10. The computer system of claim 9, wherein, when executed by said at least one processor, the computer-executable instructions further cause said at least one processor to submit the current bid price during an auction for the online content space.

11. The computer system of claim 9, wherein, when executed by said at least one processor, the computer-executable instructions further cause said at least one processor to request an update to the first inventory value by the processor to the merchant.

12. The computer system of claim 9, wherein each bidding level further includes a timeframe in which the bidding level is active.

13. The computer system of claim 9, wherein, when executed by said at least one processor, the computer-executable instructions further cause said at least one processor to receive inventory values associated with the product from a merchant on a periodic basis.

14. The computer system of claim 9, wherein, when executed by said at least one processor, the computer-executable instructions further cause said at least one processor to compare the current bid price to a plurality of bid prices associated with other merchants prior to selling the online content space to the merchant.

15. The computer system of claim 9, wherein, when executed by said at least one processor, the computer-executable instructions further cause said at least one processor to modify the plurality of bidding levels based at least in part on a plurality of historical inventory levels associated with the product.

16. The computer system of claim 9, wherein, when executed by said at least one processor, the computer-executable instructions further cause said at least one processor to:
receive, from the merchant, an advertising budget associated with the product; and
modify the plurality of bidding levels based at least in part on the advertising budget.

17. Computer-readable storage media having computer-executable instructions embodied thereon, wherein, when executed by at least one processor, the computer-executable instructions cause the processor to:
receive a plurality of bidding levels associated with a product of a merchant, each bidding level including an inventory level and a bid price;
receive a first inventory value associated with the product, the first inventory value representing the quantity of the product that the merchant has in inventory;
identify a current bidding level from the plurality of bidding levels based at least in part on comparing the first inventory value and the plurality of bidding levels, the current bidding level including a current bid price; and
sell an online content space to the merchant at the identified current bid price, the online content space for displaying the online content item to the consumer.

18. The computer program product of claim 17 further comprising instructions that when executed cause the processor to submit the current bid price during an auction for the online content space.

19. The computer program product of claim 17 further comprising instructions that when executed cause the processor to request an update to the first inventory value by the processor to the merchant.

20. The computer program product of claim 17, wherein each bidding level further includes a timeframe in which the bidding level is active.

21. The computer program product of claim 17 further comprising instructions that when executed cause the processor to receive inventory values associated with the product from a merchant on a periodic basis.

22. The computer program product of claim 17 further comprising instructions that when executed cause the processor to compare the current bid price to a plurality of bid prices associated with other merchants prior to selling the online content space to the merchant.

23. The computer program product of claim 17 further comprising instructions that when executed cause the processor to modify the plurality of bidding levels based at least in part on a plurality of historical inventory levels associated with the product.

24. The computer program product of claim 17 further comprising instructions that when executed cause the processor to:
receive, from the merchant, an advertising budget associated with the product; and
modify the plurality of bidding levels based at least in part on the advertising budget.
